(19) United States
(12) Patent Application Publication
(10) Pub. No.: US 2006/0043336 A1
(43) Pub. Date: Mar. 2, 2006

(54) Controlled charging of a photoluminescent material

(75) Inventor: Marthinus van Schoor, Medford, MA (US)

Correspondence Address: PROSKAUER ROSE LLP, ONE INTERNATIONAL PLACE 14TH FL, BOSTON, MA, 02110, US

(73) Assignee: MIDE TECHNOLOGY CORPORATION, MEDFORD, MA (US)

(21) Appl. No.: 11/211,788

(22) Filed: Aug. 25, 2005

Related U.S. Application Data
(60) Provisional application No. 60/605,189, filed on Aug. 27, 2004.

(51) Int. Cl. C09K 11/02

(52) U.S. Cl. 252/301.36

(57) ABSTRACT

A method and apparatus for controlled charging of photoluminescent materials are provided. The method involves receiving a signal associated with an operating property of a luminescent system and determining if the signal satisfies an operating criterion. Electromagnetic energy is provided to the photoluminescent material until an ambient light level in proximity to the system exceeds a predefined level. The system includes a photoluminescent material and a sensor for detecting an operating property of the luminescent system. The system includes a control module for selectively illuminating the photoluminescent material based on the operating property until the ambient light level in proximity to the luminescent system exceeds a predefined level.

### CROSS REFERENCE TO RELATED APPLICATIONS

This application claims the benefit of U.S. application Ser. No. 60/605,189, filed on Aug. 27, 2004, the entirety of which is hereby incorporated herein by reference.

### FIELD OF THE INVENTION

The invention relates to the field of illumination systems. In particular, the invention relates to controlled charging of a photoluminescent material, including method and apparatus for illuminating photoluminescent materials using light emitting diodes.

### BACKGROUND

Photoluminescent materials are substances that absorb, store and emit electromagnetic energy in the form of electromagnetic radiation. When a photoluminescent material is exposed to electromagnetic radiation in the form of photons, the photoluminescent material absorbs at least a portion of the electromagnetic radiation. The photoluminescent material can then release or emit electromagnetic radiation in the form of photons, for example, photons of visible light. A photoluminescent material can release electromagnetic radiation even when the source of electromagnetic radiation is no longer present. Photoluminescent materials can include, for example, natural or synthetic crystalline materials. When exposed to electromagnetic radiation in the form of, for example, light, these crystalline materials absorb and store energy from the light. The crystalline materials slowly and continuously release this light energy in the form of a luminous “glow”, even when the light to which the crystalline materials are exposed dims or goes out. In some applications, photoluminescent crystals are combined with various other materials to make glow-in-the-dark pigments (or polymers) which can be used in the manufacture of, for example, safety signage and pathway marking products.

Photoluminescent pigments date back to the 1940s. During the 1990s photoluminescent pigments were developed that emit a glow of sufficient brightness and duration to be used effectively in safety signage and pathway marking systems. Some photoluminescent pigments can glow for more than twenty hours. For example, a photoluminescent pigment may be exposed to a source of ultraviolet or blue light which is at least partially absorbed by the photoluminescent material in the pigment. The photoluminescent material “converts” the absorbed ultraviolet light into an alternative wavelength of light (e.g., a different color in the visible spectrum) by storing energy associated with the absorbed light and emitting light of lower energy (e.g., longer wavelength). The alternative wavelength of light may be, for example, yellow-green light that is emitted by the photoluminescent material in the pigment.

Some photoluminescent materials include rare earth elements (e.g., alkali aluminate or silicate materials) which absorb, store, and emit electromagnetic energy. In some applications, after absorbing various wavelengths of visible light for about 10 to about 20 minutes, a photoluminescent material can continuously emit light for more than 12 hours. Generally, photoluminescent materials are innocuous, non-radioactive, and stable in chemical performance. Photoluminescent materials also are self-extinguishing. More particularly, photoluminescent materials eventually stop emitting light when the energy stored from the absorbed light falls below the threshold required for the photoluminescent material to emit light.

A photoluminescent material must be energized in order for the photoluminescent material to emit light. A photoluminescent material can be energized or charged by providing electromagnetic energy to the material. Energizing a photoluminescent material requires an energy supply that provides (directly or indirectly) the electromagnetic energy to the photoluminescent material (e.g., in the form of photons) to enable emission of lower-energy photons. Continuous charging or indiscriminate charging can waste the resources (e.g., a battery or electricity) consumed by the energy supply in providing the electromagnetic energy to the photoluminescent material. Continuous or indiscriminate charging can lead to premature extinction of the luminous output of a photoluminescent material by depleting, for example, a battery provided to power a light source for charging the photoluminescent material. In some situations, it is unnecessary to charge the photoluminescent material; rather, ambient light provides light of sufficient energy for charging the photoluminescent material.

A need therefore exists for improved methods and apparatus for providing electromagnetic energy to photoluminescent materials in a luminescent system.

### SUMMARY

Several advantages are realized by the invention. The invention provides for controlled charging of a photoluminescent material. Controlled charging of a photoluminescent material prolongs the operating life of a photoluminescent material by providing electromagnetic energy to the photoluminescent material when at least one operating criterion has been satisfied. Controlled charging conserves electromagnetic energy provided to a photoluminescent system by providing (or terminating) the electromagnetic energy when the operating criterion has been satisfied. Typically, the photoluminescent material is selectively energized under specific, predetermined conditions. Photoluminescent materials may be incorporated into a variety of apparatus and apparel items to, for example, emit light and thereby alert people in the proximity of the materials to the presence of the apparatus or apparel.

The invention, in one aspect, relates to a method for controlled charging of a photoluminescent material. The method involves receiving at least one signal associated with an operating property of a luminescent system. The method also involves determining if the at least one signal satisfies at least one operating criterion. The method also involves providing electromagnetic energy to the photoluminescent material until an ambient light level in proximity of the luminescent system is greater than a predefined level.

The method also can involve terminating providing the electromagnetic energy after a predefined duration of time. In some embodiments, the method involves providing the electromagnetic energy when the photoluminescent material emits a magnitude of light greater than a predefined level. The method also can involve providing electromagnetic energy to the photoluminescent material after a predefined duration of time if the luminescent system is in motion.

The electromagnetic energy can be one or more of infrared energy, ultraviolet energy or visible light. In one embodiment, the photoluminescent material emits light in response to being charged by the electromagnetic energy. A light source can provide the electromagnetic energy. In some embodiments, the operating property includes motion, vibration, pressure, light, temperature, time, energy stored in the photoluminescent material or any combination of these.

In another aspect, the invention relates to a method for controlling the operation of a luminescent system. The method involves receiving a signal associated with ambient light in proximity to the luminescent system and charging a photoluminescent material with an electromagnetic radiation signal in response to the signal associated with ambient light. In some embodiments, the photoluminescent material absorbs lower energy electromagnetic radiation and emits higher energy electromagnetic radiation.

In another aspect, the invention features a luminescent system. The luminescent system can be used for controlled charging of a photoluminescent material. The luminescent system includes a photoluminescent material and at least one sensor for detecting at least one operating property of the luminescent system. The system also includes a control module adapted to selectively illuminate the photoluminescent material based on the operating property of the luminescent system until an ambient light level in proximity to the luminescent ‘system is greater than a predefined level.

In some embodiments, the system also includes a light source for illuminating the photoluminescent material. The light source can be a light emitting diode (e.g., one or more of an ultraviolet light emitting diode, a visible light emitting diode, and an infrared light emitting diode). In another embodiment, the at least one sensor detects motion of the luminescent system. In another embodiment, the system also includes a second sensor for detecting at least a second operating property of the luminescent system. The control module can terminate illumination of the photoluminescent material in response to the second sensor detecting a predefined level of ambient light in proximity to the luminescent system.

In some embodiments, the photoluminescent material is incorporated in an item of apparel (e.g., a shoe, sneaker, running trunks, hat, sweater or wind-breaker). In another embodiment, the control module terminates illuminating the photoluminescent material in response to the second sensor detecting a predefined level of illumination emitted by the photoluminescent material. In another embodiment, the control module terminates illuminating the photoluminescent material after a predefined duration of time. In some embodiments, the operating property includes motion, vibration, pressure, light, temperature, time, energy stored in the photoluminescent material, or any combination of these properties. In some embodiments, the photoluminescent material is an anti-Stokes photoluminescent material.

In another aspect, the invention features a luminescent system. The luminescent system includes a photoluminescent material and a light sensor for detecting ambient light in proximity to the luminescent system. The system also includes a control module adapted to selectively illuminate the photoluminescent material in response to magnitude of the ambient light detected by the light sensor. The luminescent system can be used for controlled charging of the photoluminescent material.

In another aspect, the invention features a luminescent system. The luminescent system includes a photoluminescent material and a means for detecting at least one operating property of the luminescent system. The luminescent system also includes a means for selectively illuminating the photoluminescent material based on the operating property of the luminescent system until an ambient light level in proximity to the luminescent system is greater than a predefined level. The luminescent system can be used for controlled charging of the photoluminescent material.

The foregoing and other objects, aspects, features, and advantages of the invention will become more apparent from the following description and from the claims.

### BRIEF DESCRIPTION OF THE DRAWINGS

The foregoing and other objects, features and advantages of the invention, as well as the invention itself, will be more fully understood from the following illustrative description, when read together with the accompanying drawings, which are not necessarily to scale.

FIG. 1 is a block diagram of a system for controlled charging of a photoluminescent material that embodies the invention.

FIG. 2A is a flow diagram of a method for controlled charging of a photoluminescent material that embodies the invention.

FIG. 2B is a flow diagram of a method for controlled charging of a photoluminescent material that embodies the invention.

FIG. 3A is a graphical representation of a timing diagram associated with the operation of a luminescent system, according to an illustrative embodiment of the invention.

FIG. 3B is a graphical representation of a timing diagram associated with the operation of a luminescent system, according to an illustrative embodiment of the invention.

FIG. 4 is a perspective view of a sign incorporating photoluminescent materials, according to an illustrative embodiment of the invention.

FIG. 5 is a schematic view of a sneaker incorporating photoluminescent materials, according to an illustrative embodiment of the invention.

### DETAILED DESCRIPTION

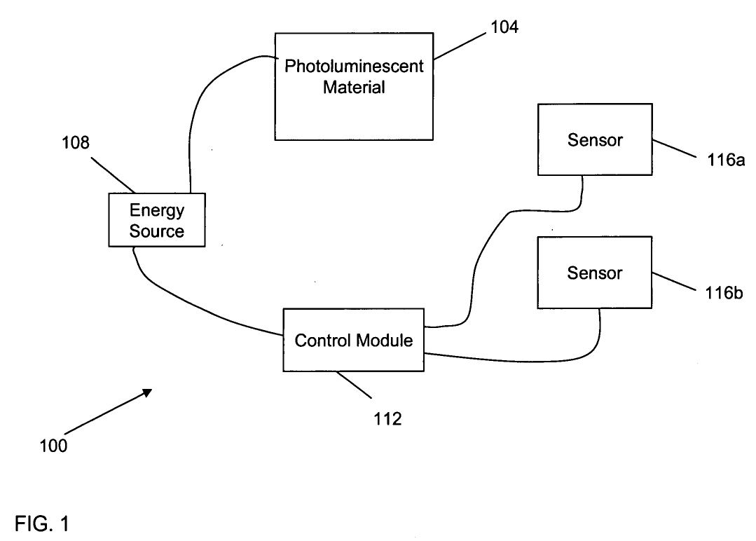

FIG. 1 is a block diagram of a system for controlled charging of a photoluminescent material that embodies the invention. The system 100 includes a photoluminescent material 104 and an electromagnetic energy source 108 that selectively provides electromagnetic energy to the photoluminescent material 104. In some embodiments, the electromagnetic energy is light. As used herein, light refers to ultraviolet light (e.g., electromagnetic energy having wavelengths between about 10 nm and about 380 nm), visible light (e.g., electromagnetic energy having wavelengths between about 380 nm and about 700 nm), and infrared light (e.g., electromagnetic energy having wavelengths between about 700 nm and about 1 mm). In some embodiments, the electromagnetic energy source 108 provides electromagnetic energy of a single wavelength to the photoluminescent material 104. Light of a single wavelength is referred to as monochromatic light. In some embodiments, the electromagnetic energy source 108 can provide electromagnetic energy of multiple wavelengths to the photoluminescent material 104.

In embodiments in which the electromagnetic energy is light, providing the electromagnetic energy to the photoluminescent material 104 is referred to as illuminating the photoluminescent material. The energy source 108 “charges” the photoluminescent material 104 by directing electromagnetic energy in the form of electromagnetic radiation to a surface of the photoluminescent material 104. The photoluminescent material 104 stores the electromagnetic energy and emits light (e.g., “glows”) after the energy source 108 has stopped providing electromagnetic energy to the photoluminescent material 104. The time delay during which the photoluminescent material 104 glows is referred to as relaxation or decay time because the electromagnetic energy that the photoluminescent material 104 emits decreases over time. The relaxation or decay time is associated with solid-state dissipation of the absorbed energy that is stored in the photoluminescent material 104. The relaxation or decay time varies based on, for example, the type of photoluminescent material used in a particular embodiment of the invention. The relaxation or decay time can also vary based on, for example, the temperature of the photoluminescent material, the amount of energy stored in the photoluminescent material, or other initial conditions.

In some embodiments, the photoluminescent material 104 is an anti-Stokes photoluminescent material. An anti-Stokes photoluminescent material can be referred to as an “up-converter” because it absorbs lower energy electromagnetic radiation and emits higher energy electromagnetic radiation. In some anti-Stokes materials, one unit (e.g., photon) of higher electromagnetic energy is emitted for two units of lower electromagnetic energy absorbed. An anti-Stokes photoluminescent material glows under the reverse process of phosphors and fluors, in which higher energy electromagnetic radiation is absorbed and lower electromagnetic radiation is emitted.

In some embodiments, up-converter photoluminescent materials (e.g., pigments or polymers) absorb near-infrared electromagnetic radiation (e.g., of wavelengths approximately 980 nm) and emit visible light. An infrared laser can provide the electromagnetic radiation. In other embodiments, a relatively low-powered infrared diode (e.g., a low-powered infrared LED) provides sufficient electromagnetic radiation to result in brighter shades of visible light from the photoluminescent material 104. In general, anti-Stokes photoluminescent materials do not emit visible light when the electromagnetic radiation absorbed is in the ultraviolet spectrum.

The system 100 also includes a control module 112 in communication with the energy source 108. The control module 112 provides a signal to the energy source 108 to selectively direct the energy source 108 to illuminate the photoluminescent material 104. Similarly, the control module 112 can provide a signal to the energy source 108 to selectively direct the energy source 108 to stop illuminating the photoluminescent material 104 (terminating providing electromagnetic energy to the photoluminescent material 104). The control module 112 can include, for example, various electronic circuitry. In one embodiment, the control module 112 includes a PIC18F4220 microchip sold by Microchip Technology Inc. of Chandler, Ariz.

The system 100 also includes a first sensor 116a and a second sensor 116b (generally 116). In some embodiments, the system 100 and the components of the system are integrated into or associated with a structure. The structure can be, for example, an electronic “bread board,” an article of apparel, a surface, or other configurations capable of integrating the components of the system and allowing the various components to communicate. In some embodiments, the first sensor 116a and the second sensor 116b are physically co-located on a single structure.

Each of the first sensor 116a and the second sensor 116b detects one or more operating parameters or criteria associated with the system 100 or its surroundings. The first sensor 116a can detect at least one operating parameter of the system 100. The operating parameter can include, for example, motion, vibration, pressure, light, temperature, time, energy stored in the photoluminescent material 104 or any combination of these. The first sensor 116a is in communication with the control module 112 and provides a signal to the control module 112 based on the at least one operating parameter. The control module 112 selectively provides a signal to the energy source 108 when the at least one operating parameter satisfies a selection criterion. For example, when the system 100 is in motion, the first sensor 116a can detect motion of the system 100 and provide a signal to the control module 112 indicating that the system 100 is in motion or is accelerating. An exemplary sensor for measuring motion is an ADXL 50 accelerometer sold by Analog Devices, Inc. of Norwood, Mass. The sensor detects, for example, acceleration or vibration. Other motion sensors can be used, including those used in motion detectors, inclinometers, and strain sensors measuring deformation of the material that is used. The control module 112 provides a signal to the energy source 108 when the signal from the first sensor 116a is greater than a predetermined threshold.

In this embodiment, when the system 100 is in motion, the energy source 108 charges the photoluminescent material 104 by illuminating the photoluminescent material. The energy source 108 stops charging the photoluminescent material 104 when motion ceases (e.g., the first sensor 116a provides a signal to the control module 112 that, for example, the motion of the system 100 falls below a predefined threshold). The photoluminescent material 104 glows as a result of having been previously charged by the energy source 108.

The system 100 also includes a second sensor 116b that detects at least one operating parameter of the system 100. The second sensor 116b is in communication with the control module 112 and provides a signal to the control module 112 based on the at least one operating parameter. In this embodiment, the second sensor 116b measures the light level in proximity to the system 100 and, particularly, the second sensor 116b. The second sensor 116b can detect ambient light (e.g., provided from a source external to the system 100) or light associated with the system 100 (e.g., provided from the glow of the photoluminescent material 104). The second sensor 116b can include, for example, a photovoltaic cell that measures ambient light or the glow of the photoluminescent material 104 and generates an electric signal in response to the light. For example, when the second sensor 116b measures ambient light levels above a threshold value, for example when the light is greater than about 350 lumens in proximity to the system 100, the control module 112, provides a signal to the energy source 108 to terminate providing electromagnetic energy to the photoluminescent material 104. By way of comparison, a 40 Watt incandescent light bulb produces a light intensity of about 700 lumens. In some embodiments, either the first sensor 116a or the second sensor 1116b can detect the light emitted by the photoluminescent material 104 and can provide a signal associated with the light to the control module 112.

In some embodiments, a sensor 116 detects the light emitted by the photoluminescent material 104. The sensor 116 communicates with the control module 112 to ensure that the energy source 108 provides an amount of electromagnetic energy to the photoluminescent material 104 sufficient to maintain a brightness of the photoluminescent material above a predefined level of brightness. Such an embodiment can be used, for example, to maintain the brightness of an emergency sign employing the system 100.

In some embodiments, the sensor 116 includes a pressure sensor that measures pressure applied to a portion of the system 100. When the sensor 116 detects a pressure that is greater than a predetermined threshold, the sensor provides a signal to the control module 112. The control module 112 provides a signal to the energy source based in part on the signal from the sensor 116. By way of example, the system 100 may be incorporated into an item of apparel, and the sensor 116 may be a pressure sensor adapted to measure pressure applied to a location on the item of apparel. Strain or piezoelectric pressure sensors are exemplary pressure sensors that are suitable for use in the system 100.

In some embodiments, the control module 112 includes a time signal or clock signal, or the sensor 116 provides a time signal or a clock signal to the control module 112. For example, the sensor 116 can provide a signal to the control module 112 after a predefined duration of time to direct the control module 112 to provide a signal to the energy source 108. In this manner, the control module 112 controls the start time and duration for the energy source 108 to charge the photoluminescent material 104. In other embodiments, the time signal can be combined with signals associated with other operating parameters. For example, the control module 112 can direct the energy source 108 to charge the photoluminescent material 104 only once during a time period in which the operating parameter exceeds a threshold value.

In some embodiments, the operating parameter is the temperature associated with the system 100. In such embodiments, sensor 116 is a thermal sensor that detects the temperature of the system 100 (e.g., components of the system 100) or of the environment in proximity to the system 100. In one embodiment, the sensor 116 detects the temperature of the photoluminescent material 104 and provides a signal based on the temperature to the control module 112. The control module 112 directs the energy source 108 to provide electromagnetic energy to the photoluminescent material 104 based on the temperature. For example, when the temperature of the photoluminescent material 104 falls below a particular value, the control module 112 directs the energy source 108 to illuminate the photoluminescent material 104. In general, both brightness and decay times of a photoluminescent material are temperature-dependent. In some embodiments, the sensor 116 for detecting temperature is a model AD22100 sensor sold by Analog Devices, Inc. of Norwood, Mass. In some embodiments, the temperature sensors can be resistance temperature detector-type (“RTD”) thermal sensors. RTD sensors are manufactured from metals whose resistance increases with temperature. Within a particular temperature range, the resistivity of the particular material increases substantially linearly as the temperature increases. By monitoring this resistance change, the temperature of the material can be determined from the output of the RTD sensor.

In some embodiments, the operating parameter measured by a sensor 116 is the energy stored in the photoluminescent material 104. In general, brightness and decay time of the photoluminescent material 104 depend on the energy stored in the photoluminescent material (e.g., as an initial condition of the system 100). Sensor 116 can detect one or more physical properties (e.g., temperature of the photoluminescent material 104 and duration of time the photoluminescent material 104 is illuminated) associated with the stored energy to determine the energy remaining in the photoluminescent material 104. The amount of energy remaining in the photoluminescent material 104 can be determined, for example, experimentally, empirically, or theoretically. In such an embodiment, the sensor 116 provides a signal to the control module 112 based on the stored energy. For example, when the energy stored in the photoluminescent material 104 exceeds a predetermined level, the sensor 116 provides a signal to the control module 112 to direct the energy source 108 to terminate illuminating the photoluminescent material 104. When the energy stored in the photoluminescent material 104 falls below the predetermined level, the sensor 116 provides a signal to the control module 112 to direct the energy source 108 to illuminate the photoluminescent material 104. In some embodiments, the electromagnetic energy source 108 is a light source. For example, the energy source 108 can be a light-emitting diode (LED) in proximity to the photoluminescent material 104 such that the LED illuminates the photoluminescent material 104. Light emitting diodes (LEDs) are electrical devices made from semiconductor materials (e.g., crystalline materials such as silicon, germanium or gallium arsenide). Semiconductors possess both conductive and insulative electrical properties and allow current to flow under certain circumstances. Band-gap is a property associated with semiconductor materials associated with the amount of energy required to move an electron from the valence band up into the conduction band of the semiconductor (e.g., through an interaction with a photon of light, for example, absorption). Conversely, the band-gap represents the minimum energy emitted as a photon (e.g., a photon of light) when an electron moves from the conduction band to the valence band. The energy of the emitted photon determines the frequency and wavelength of the light. Thus, the larger the band-gap of an LED, the more energy contained in the photons of light emitted. Band-gap may also be described as an indication of the electrical pressure required to dislodge electrons from the parent semiconductor atoms.

The control module 112 provides electrical power (e.g., an operating input signal) to the LED (energy source 108), causing the LED to emit electromagnetic energy (e.g., light). The electrical power can be an electric potential across the terminals of the LED (e.g., from a power supply). When the operating input signal has energy that is greater than the band-gap of the semiconductor material that forms the LED, the operating input causes a valence-band electron to move up or “jump” to the conduction band by absorbing some of the energy associated with the operating input. When an electron returns from the conduction band to the valence band, a photon is emitted. In this way, the power supply powers or drives the LED by providing an operating input signal.

The type of the light generated by a semiconductor material is determined by the frequency or the wavelength of the emitted photons of light. The frequency or wavelength of the light depends on the energy expended to generate each photon (e.g., the band-gap). Changes to the band-gap of a material are related to the color of the light emitted from the semiconductor material. Variously-colored LEDs may be produced by varying the compositional or structural properties of elements in a semiconductor crystal. LEDs are available that produce electromagnetic radiation, for example, in the near infrared range (used in, for example, TV remote controls) to the ultraviolet range of electromagnetic radiation. Light generated by an LED is generally monochromatic.

Ultraviolet LEDs are a specific type of LED that produce ultraviolet light. Similarly, infrared LEDs are a specific type of LED that produce infrared light, and visible light LEDs are a specific type of LED that produce visible light. In some embodiments, the photoluminescent material 104 absorbs ultraviolet light more efficiently than infrared light. Less ultraviolet light (e.g., light of lower energy and/or light applied for a shorter time duration) is therefore required to adequately charge a photoluminescent material than would otherwise be required using infrared or visible light.

LEDs are generally very efficient and, in normal use, generate little discernable heat. LEDs tend to enjoy relatively long useful lives when the LEDs are operated below maximum rating. For example, the mean-time-between-failures for some LEDs can be as much as 100,000 hours. The Optoelectronics Division of Lumileds Lighting, LLC of San Jose, Calif. sells LEDs with mean-time-between-failures greater than 300,000 hours. LEDs consume relatively little current from the power supply, for example, about 20 mA to produce light that is visible to the human eye. In contrast, a filament bulb draws about 100 mA to produce an equivalent amount of visible light because some of the energy provided to the filament is radiated as infrared light (e.g., heat) that is not visible to the human eye. The voltage or electric potential developed across an LED is determined by its band-gap and is generally independent of the current provided by the power supply. Typical band-gap values range from about 2 Volts to about 5 Volts, depending on the physical construction parameters of the LED and the energy (e.g., the wavelength) of the light produced. The current flowing through the LED can be set or regulated, for example, by an electrical resistance in series with the LED. The value of the electrical resistance is selected to allow the desired current to flow through the LED at the desired voltage. In some embodiments, control module 112 includes the in-series resistance. In other embodiments, the LED (e.g., energy source 108) includes or provides the in-series resistance.

The control module 112 provides controlled charging of the energy source 108 based on one or more operating parameters or criteria, as previously described herein. In some embodiments, the control module 112 provides a signal to the energy source 108 directing the energy source 108 to provide electromagnetic energy to the photoluminescent material 104 based on more than one operating parameter. For example, the control module 112 can provide a signal to the energy source 108 to illuminate the photoluminescent material 104 for a predetermined duration of time (e.g., when the control module 112 is coupled to a time-delay circuit, a clock signal, or when the sensor 116 performs timing operations) while the system 100 is in motion as detected by the sensor 116. In some embodiments, when the predetermined duration of time expires, the energy source 108 terminates or ceases providing electromagnetic energy to the photoluminescent material 104 regardless of the state or value of the operating parameter. After a second predetermined duration of time, if the system 100 is still in motion as determined by the signal provided to the control module 112 by the sensor 116, the energy source 108 again provides electromagnetic energy to the photoluminescent material 104. The first and second predetermined durations of time can be referred to as a cycle or charging cycle.

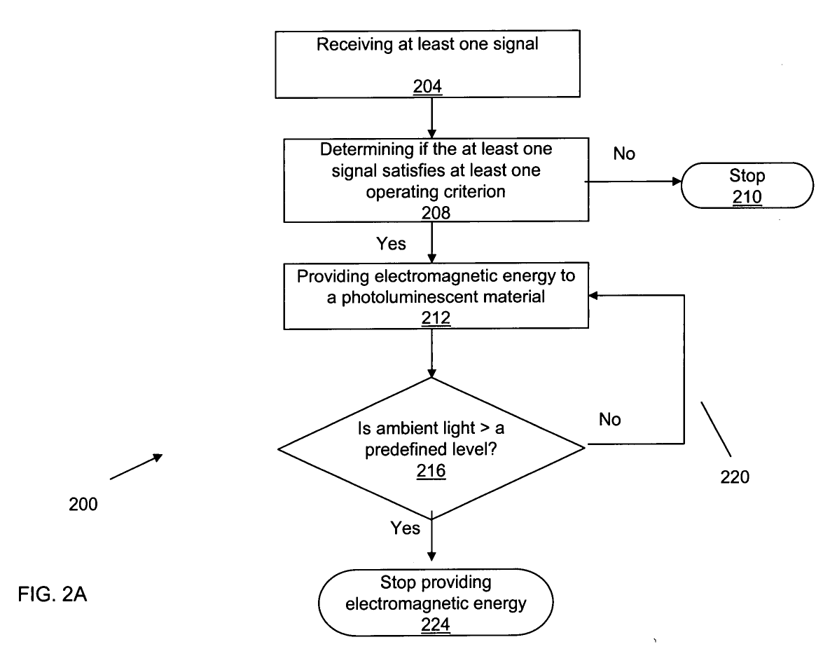

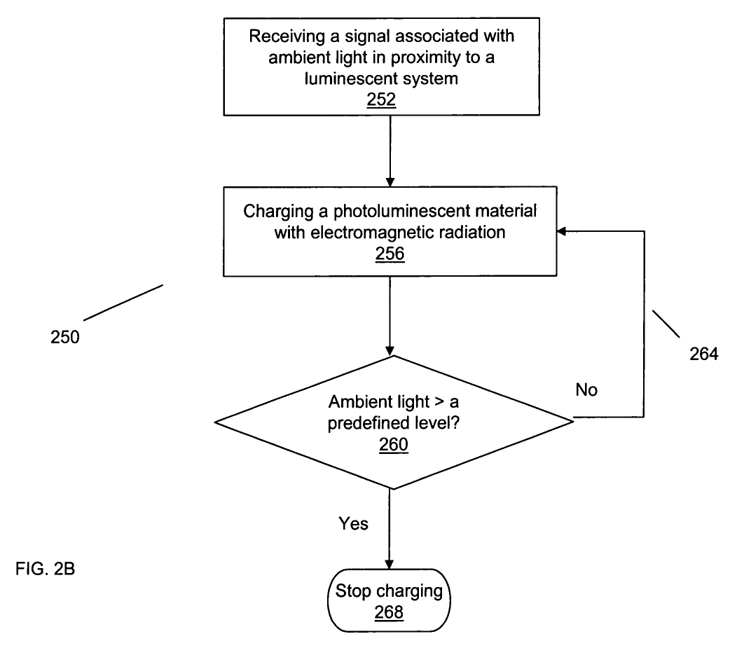

FIG. 2A is a flow diagram 200 of a method for controlled charging of a photoluminescent material that embodies the invention. Step 204 involves receiving at least one signal associated with an operating property of the luminescent system. In some embodiments, Step 204 is performed by the control module 112 or the sensor 116 of the system 100 depicted in FIG. 1. Step 208 involves determining if the at least one signal of Step 204 satisfies at least one operating criterion. Step 208 can be performed, for example, by the control module 112 or electrical circuitry in the sensor 116. If the at least one signal does not satisfy the operating criterion, electromagnetic energy is not provided to the luminescent system (e.g., Step 210). If the signal does satisfy the operating criterion, electromagnetic energy is provided to the luminescent system (e.g., Step 212). Step 216 involves determining whether ambient light exceeds a predefined level. A feedback loop 220 is associated with providing electromagnetic energy to a photoluminescent material until the ambient light level in proximity to the luminescent system is greater than the predefined level. For example, when the ambient light in proximity to the luminescent system (e.g., the system 100 of FIG. 1) does not exceed the predefined level, the system continues to provide electromagnetic energy to the photoluminescent material (e.g., Step 212). When the ambient light in proximity to the luminescent material does exceed a predefined level, the method involves terminating providing electromagnetic energy to the photoluminescent material (Step 224).

FIG. 2B is a flow diagram 252 of a method for controlled charging of a photoluminescent material that embodies the invention. Step 252 involves receiving a signal associated with ambient light in proximity to a luminescent system (e.g., in proximity to the system 100 of FIG. 1). In this embodiment, the ambient light is detected by the sensor 116 of FIG. 1. In this embodiment, the sensor 116 is a photovoltaic cell that outputs the signal associated with ambient light in proximity to the luminescent system. The output of the sensor 116 is based on a property of the ambient light (e.g., wavelength, frequency, and/or amplitude). Step 256 involves charging a photoluminescent material with an electromagnetic radiation signal (e.g., by using the energy source 108 to illuminate the photoluminescent material 104). In this embodiment, the method also involves determining whether the ambient light exceeds a predefined level (Step 260). When the ambient light does not exceed the predefined level, a feedback loop 264 enables continued charging of the photoluminescent material with electromagnetic radiation (Step 256). When the ambient light does exceed the predefined level, Step 268 involves stopping or terminating the charging of the photoluminescent material (Step 256).

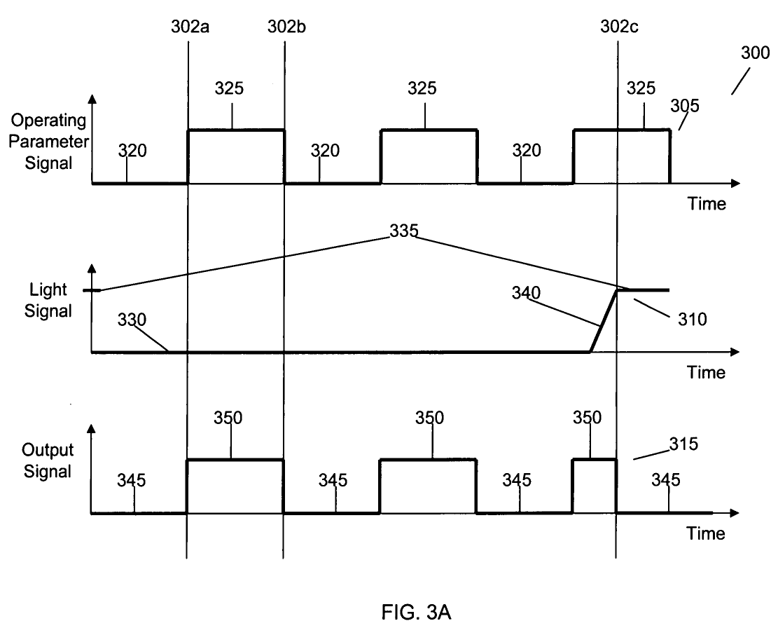

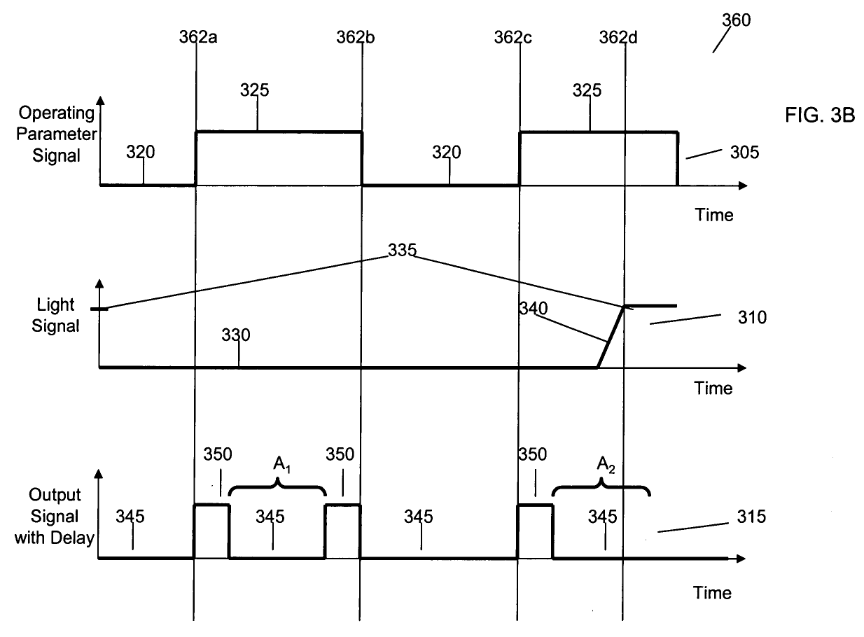

FIG. 3A is a graphical representation of a timing diagram associated with the operation of a luminescent system, according to an illustrative embodiment of the invention. The timing diagram 300 depicts three discrete points in time 302a, 302b, and 302c, referred to herein as an individual time (e.g., time 302a) or a collection of times (e.g., times 302a-302c). The timing diagram 300 also depicts a first signal 305, a second signal 310 and a third signal 315. The third signal 315 represents a combination of the first signal 305 and the second signal 310 as a function of time. The first signal 305 is associated with an operating parameter of a luminescent system (e.g., the system 100 of FIG. 1). In this embodiment, the first signal 305 is the output of the sensor 116a of FIG. 1. More particularly, the first signal 305 can occupy a first state 320 (e.g., “off” or “0”) or a second state 325 (e.g., “on” or “1”). The first signal 305 occupies the first state 320 when the operating parameter associated with the luminescent system as detected by the sensor 116a does not exceed a predetermined value. The first signal 305 occupies the second state 325 when the operating parameter associated with the luminescent system does exceed the predetermined value. In this embodiment, the first signal 305 is an input to the control module 112 of FIG. 1.

The second signal 310 is associated with ambient light in proximity to the luminescent system (e.g., the system 100). The second signal 310 is associated with the output of the sensor 116b of FIG. 1. The second signal can occupy a first state 330 (e.g., “off” or “0”), a second state 335 (e.g., “on” or “1”), or a third state 340 (e.g., ramping between the first state 330 and second state 335 as the ambient light increases). In some embodiments, no third state 340 is present, and changes between the first state 330 and the second state 335 are substantially instantaneous (the third state 340 is a substantially vertical line. The second signal 310 occupies the first state 330 when the ambient light in proximity to the luminescent system (e.g., as detected by the sensor 116b) does not exceed a predetermined value. The second signal 310 occupies the second state 335 when the ambient light in proximity to the luminescent system does exceed the predetermined value. The second signal is a second input for the control module 112 of FIG. 1.

The third signal 315 is associated with providing electromagnetic energy or radiation to a photoluminescent material (e.g., the photoluminescent material 104 of FIG. 1). In some embodiments, the third signal 315 is the output from the control module 112 of FIG. 1 to the energy source 108 that directs the energy source 108 to illuminate the photoluminescent material 104. In other embodiments, the third signal 315 represents the output of the energy source 108 (e.g., a command to illuminate the photoluminescent material 104). The third signal 310 can occupy a first state 345 (e.g., “off” or “0”) or a second state 350 (e.g., “on” or “1”). The first state 345 of the third signal 315 occurs when the first signal 305 is in the first state 320 and the second signal 310 is in the first state 330 or the second state 335. More particularly, the first state 345 occurs when either the operating parameter associated with the luminescent system is less than the predetermined threshold (see the first signal 305) or when the ambient light in proximity to the luminescent system exceeds a predetermined value (e.g., depicted as the area to the left of time 302a of the second signal 310 on the timing diagram 300).

The second state 350 of the third signal 315 occurs when the first signal 305 occupies the second state 325 and the second signal 310 occupies the first state 330. More particularly, the second state 350 occurs when the operating parameter associated with the luminescent system exceeds a predetermined level and the ambient light in proximity to the luminescent system does not exceed a predetermined level (e.g., between time 302a and time 302b on the timing diagram 300). As used herein, “state” refers to a physical characteristic of the system 100 and the first signal 305, second signal 310, and third signal 315. Referring to a particular state as “0” or “1” or, respectively, “off” or “on” is for convenience. Other labeling conventions may be used without departing from the scope of the disclosure. Table 1 below illustrates the state of the third signal 315 (as determined, for example, by the control module 112) as a function of the combined states of each of the first signal 305 and the second signal 310.

TABLE 1

| First signal 305 | Second signal 310 | Third signal 315 |
|---|---|---|
| State 320 (0 or off) | State 330 (0 or off) | State 345 (0 or off) |
| State 325 (1 or on) | State 330 (0 or off) | State 350 (1 or on) |
| State 320 (0 or off) | State 335 (1 or on) | State 345 (0 or off) |
| State 325 (1 or on) | State 335 (1 or on) | State 345 (0 or off) |

FIG. 3B is a graphical representation of a timing diagram 360 associated with the operation of a luminescent system, according to an illustrative embodiment of the invention. The timing diagram 360 depicts four discrete points in time 362a, 362b, 362c, and 362d, referred to herein individually as time (e.g., time 362a) or collectively as times (e.g., times 362a-362d). The timing diagram 360 also depicts the first signal 305 and second signal 310 of FIG. 3A a third signal 365. The third signal 365 includes a time delay A to conserve resources associated with controlled charging of a photoluminescent material 104.

At time 362a, the operating parameter associated with the luminescent system 100 exceeds a predetermined value, and the first signal 305 occupies the second state 325. The first signal 305 occupies the first state 325 until time 362b. During the interval between the time 362a and the time 362b, the second signal 310 occupies the first state 330 (e.g., ambient light is less than a predetermined level). The third signal 365 includes a delay A₁ in the interval between the time 362a and the time 362b during which the third signal 365 occupies the first state 345. More particularly, at the time 362a, the third signal 365 occupies the second state 350 for a fixed duration of time until the delay A₁ begins. After the delay A₁, the operating parameter still exceeds the predetermined level, and the third signal 365 again occupies the second state 350 until the first signal 305 returns to the first state 320 at the time 362b.

Between the time 362b and the time 362c, the third signal 365 occupies the first state 345 because the first signal 305 occupies the first state 320, and the second signal 310 occupies the first state 330. At the time 362c, the first signal 305 occupies the second state 325 because the operating parameter exceeds a predetermined level. The third signal 365 again occupies the second state 350 for a fixed duration of time until the delay A₁ begins. At the time 362d (during the delay A₂), ambient light in proximity to the luminescent system 100 exceeds a predetermined level, and the second signal 310 occupies the second state 335. After the time 362d, the third signal 365 occupies the first state 345 because the ambient light is sufficient to charge the photoluminescent material 104. After the time 362d, the photoluminescent material 104 is not illuminated by the energy source 108 because ambient light in proximity to the system 100 is sufficient to charge the photoluminescent material 104. The system 100 in such a configuration is referred to as disabled.

In some embodiments, properties of the delays A₁ and A₂ (e.g., duration or conditions under which the control module initiates a delay) is a feature of the control module 112. More particularly, time-delay circuitry is associated with the control module 112 such that after a predetermined duration of time (e.g., the delay A₁), the control module 112 terminates providing a signal to the energy source 108. After the delay A₁ if an operating parameter (e.g., motion) associated with the luminescent system 100 still exceeds a predetermined value (e.g., the system remains in motion after the delay A₁), the control module 112 will resume providing a signal to the energy source 108 again. In some applications, this feature of the system may be referred to as “sleep” mode.

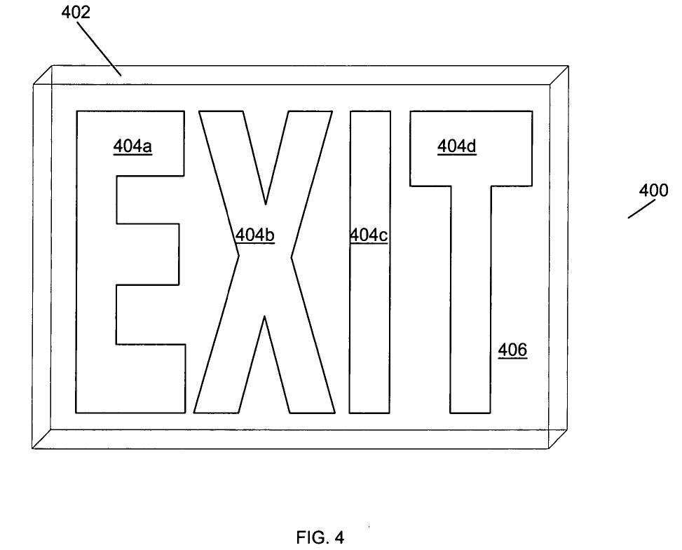

FIG. 4 is a perspective view of a sign incorporating photoluminescent materials, according to an illustrative embodiment of the invention. The sign 400 depicted includes a three-dimensional housing 402, used as an “EXIT” sign. In some embodiments, a luminescent system (e.g., the system 100 of FIG. 1) is located within the housing 402. The sign 400 includes portions 404a, 404b, 404c, and 404d that have been removed from a side of the housing 402 for allowing electromagnetic energy to enter and exit the housing 402. After charging, the luminescent system 100 illuminates the inside of the housing 402, and electromagnetic energy (e.g., light) passes through the portions 404a-404d. The juxtaposition of the portions 404a-404d with the non-illuminated side 406 of the housing 402 allows the portions 404a-404d of the sign 400 to be visible in the dark to form words. In some embodiments, ambient light is detected by the luminescent system (e.g., by a sensor 116b located external to the sign 402) as it passes through the portions 404a-404d. In some embodiments, the system 100 is located within or external to other types of signs including road construction signs. The system 100 can be located on an exterior surface of such signs and need not be disposed in a housing. In some embodiments, the portions 404a-404d are patterns of photoluminescent material disposed on a surface (e.g., the side 406 of the housing 402) with nonluminescent materials interposed between the portions 404a-404d. The juxtaposition of the portions 404a-404d (e.g., the photoluminescent material 104) with nonluminescent material of the side 402 allows the portions 404a-404d to be visible. Other embodiments can be used to create signs that employ controlled charging of a photoluminescent material with, e.g., the system 100 of FIG. 1.

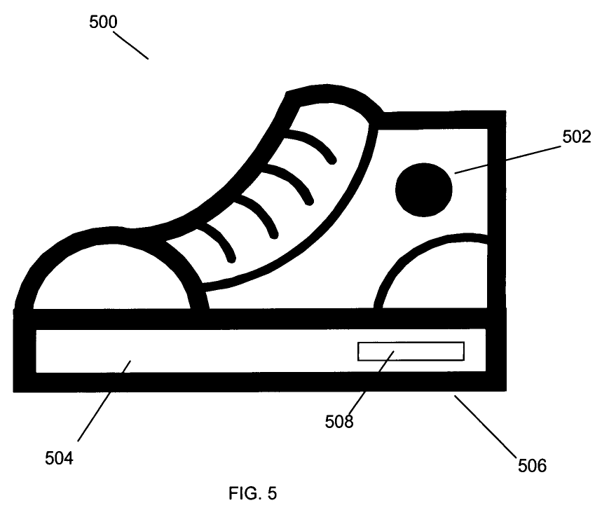

FIG. 5 is a schematic view of a sneaker incorporating photoluminescent materials, according to an illustrative embodiment of the invention. The illustrated embodiment depicts a particular article of clothing, namely a sneaker 500. The sneaker 500 includes an upper portion 502 that is used to secure the sneaker 500 to the foot of the wearer. The sneaker 500 also includes a sole 504 in which a luminescent system (e.g., the system 100 of FIG. 1) is located. In some embodiments, the system 100 is located in a heel portion 506 of the sole 504. Electromagnetic energy interacts with the system 100 through a window 508 into the sole 504. More particularly, electromagnetic energy enters the window 508 and interacts with the luminescent system 100, for example, the sensor 116b. The window 508 is made of a material permeable by electromagnetic energy (e.g., light including ambient light). When the photoluminescent material 104 emits light, some of the light exits the sole 504 through the window 508 and is visible to observers external to the system.

The system 100 can be employed for novelty purposes or to increase the visibility of the wearer, or both. In some embodiments, a photoluminescent material (e.g., the photoluminescent material 104 of FIG. 1) coats the fabrics from which an article of apparel is made (e.g., the upper portion 502). In other embodiments, the fabrics from which an article of apparel is made are fabricated from photoluminescent materials. Other apparel embodiments not illustrated (e.g., hats, sweaters, vests, coats or jackets, shirts, pants, backpacks, or the like) may employ controlled charging of photoluminescent materials without departing from the scope of the invention. The system 100 can be employed in non-clothing embodiments such as glow sticks or glow rings. Unlike conventional glow sticks or glow rings that employ a chemical reaction to provide illumination, the system 100 can be recharged for multiple uses.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method for controlled charging of a photoluminescent material, comprising:
receiving at least one signal associated with an operating property of a luminescent system;
determining if the at least one signal satisfies at least one operating criterion; and
providing electromagnetic energy to the photoluminescent material until an ambient light level in proximity to the luminescent system is greater than a predefined level.

2. The method of claim 1, wherein the electromagnetic energy comprises infrared energy, ultraviolet energy, or visible light.

3. The method of claim 1, wherein the photoluminescent material emits light in response to being charged by the electromagnetic energy.

4. The method of claim 1, wherein a light source provides the electromagnetic energy.

5. The method of claim 1, further comprising terminating providing the electromagnetic energy after a predefined duration of time.

6. The method of claim 1, wherein the ambient light comprises light emitted from the photoluminescent material.

7. The method of claim 1, further comprising providing electromagnetic energy to the photoluminescent material after a predefined duration of time if the luminescent system is in motion.

8. The method of claim 1, wherein the operating property comprises motion, vibration, pressure, light, temperature, time, energy stored in the photoluminescent material, or any combination thereof.

9. A method for controlled charging of a photoluminescent material, comprising:
receiving a signal associated with ambient light in proximity to a luminescent system; and
charging the photoluminescent material with an electromagnetic radiation signal in response to the signal associated with ambient light.

10. The method of claim 9, wherein the photoluminescent material is charged with lower energy electromagnetic radiation and the photoluminescent material emits higher energy electromagnetic radiation.

11. A luminescent system comprising:
a photoluminescent material;
at least one sensor for detecting at least one operating property of a luminescent system; and
a control module adapted to selectively illuminate the photoluminescent material based on the operating property of the luminescent system until an ambient light level in proximity to the luminescent system is greater than a predefined level.

12. The system of claim 11, further comprising a light source for illuminating the photoluminescent material.

13. The system of claim 12, wherein the light source is a light emitting diode.

14. The system of claim 13, wherein the light emitting diode comprises an ultraviolet light emitting diode, a visible light emitting diode, an infrared light emitting diode, or any combination thereof.

15. The system of claim 11, further comprising a second sensor for detecting at least a second operating property of the luminescent system.

16. The system of claim 15, wherein the control module terminates illumination of the photoluminescent material in response to the second sensor detecting a predefined level of ambient light in proximity to the luminescent system.

17. The system of claim 15, wherein the control module terminates illuminating the photoluminescent material in response to the second sensor detecting a predefined level of illumination emitted by the photoluminescent material.

18. The system of claim 11, wherein the photoluminescent material is incorporated in an item of apparel.

19. The system of claim 18, wherein the item of apparel comprises a shoe, sneaker, running trunks, hat, sweater, wind-breaker, or any combination thereof.

20. The system of claim 11, wherein the control module terminates illuminating the photoluminescent material after a predefined duration of time.

21. The system of claim 11, wherein the operating property comprises motion, vibration, pressure, light, temperature, time, energy stored in the photoluminescent material or any combination thereof.

22. The system of claim 11, wherein the photoluminescent material is an anti-Stokes photoluminescent material.

23. A luminescent system comprising:
a photoluminescent material;
a light sensor for detecting ambient light in proximity to the luminescent system; and
a control module adapted to selectively illuminate the photoluminescent material in response to magnitude of the ambient light detected by the light sensor.

24. A luminescent system comprising:
a photoluminescent material;
a means for detecting at least one operating property of the luminescent system; and
a means for selectively illuminating the photoluminescent material based on the operating property of the luminescent system until an ambient light level in proximity to the luminescent system is greater than a predefined level.
